(19) United States
(12) Patent Application Publication
(10) Pub. No.: US 2013/0286783 A1
(43) Pub. Date: Oct. 31, 2013

(54) TARGET DETECTION AND TRACKING WITH MULTIPLE ULTRASONIC TRANSDUCERS

(71) Applicants: Michael Sussman, Winchester, MA (US); Stephen Hersey, Waltham, MA (US)

(72) Inventors: Michael Sussman, Winchester, MA (US); Stephen Hersey, Waltham, MA (US)

(21) Appl. No.: 13/456,915

(22) Filed: Apr. 26, 2012

(51) Int. Cl. G01S 15/00

(52) U.S. Cl. 367/93

(57) ABSTRACT

In an ultrasonic detection system utilizing multiple ultrasound transducers capable of both transmitting and receiving detection signals, the transducers are selectively operated to achieve immunity to ringdown delays or to optimize the detection of distant objects. For example, in one embodiment, object detection is performed within the field of a particular transducer channel by suppressing rather than activating that transducer; instead, the adjacent transducers on either side of the selected channel are driven simultaneously, and the selected channel's transducer is used only to receive.

### TECHNICAL FIELD

In various embodiments, the present invention relates generally to ultrasonic motion detectors implemented in automated industrial systems.

### BACKGROUND

Automated industrial systems, e.g., autonomous robots, have been developed to be more self-sufficient since the emergence of the first manufactured robots over half a century ago. Unlike the earliest robots, contemporary devices require less human assistance; they are capable of independently functioning and completing tasks in various types of unstructured environments. However, bringing robots and humans into spatial proximity leads to the fundamental concern of how to ensure safety for the human. A heavy industrial robot with powerful actuators and unpredictably complex behavior can cause harm, for instance, by stepping on a human's foot or falling on him. Therefore, detecting the presence of moving objects in the vicinity of robots is crucial for ensuring the safety of people working near the robotic system.

One approach is to equip the robot with motion-detection capabilities. Various motion-detecting technologies exist, including passive infrared detectors (PIRs), Doppler microwave sensors, ultrasonic rangefinders, scanned laser rangefinders, vision-based systems, pressure-sensitive mats, and arrays of infrared emitter/detector pairs, which are known as “light curtains.” PIRs are commonly used for intrusion detection systems; they provide high sensitivity to the presence of warm moving objects. However, PIRs have very wide detection angles (typically 90° to 180°) and are incapable of estimating the distance between moving objects and the robots; they thus provide inadequate data on the bearing (velocity) of a detected human. Doppler microwave sensors sense moving objects over a wide field of view; however, they provide neither range (distance) nor bearing (velocity) information. Additionally, multiple Doppler systems can interfere with each other, precluding their deployment as multichannel systems or on multiple robots. Scanned laser rangefinders can provide excellent range and bearing data; they have fields of view up to 180°. However, scanned laser rangefinders are expensive and present a potential vision hazard from the bright laser light source. In addition, scanned laser rangefinders sense objects along a narrow plane; this requires precise adjustments of the laser to ensure detection of, for example, humans of various heights. Further, scanned laser rangefinders do not distinguish moving objects from stationary ones; they thus require significant computational overhead on the part of the robot controller.

Vision-based systems are expensive and require significant amounts of computing power to reliably detect and locate moving objects. Pressure-sensitive mats can provide good data on the location of the objects, but they are susceptible to damage and wear. In addition, pressure-sensitive mats require unobstructed floor areas for operation; this may not be available in industrial factories. Light curtains require the presence of restricted-access “choke points” at which to locate the sensors and thus are difficult to install. Further, light curtains can sense only along a line at the light curtain location and therefore have a limited field of view.

Ultrasonic rangefinders used in the robotics industry are relatively inexpensive and easy to interface. Additionally, these components have relatively narrow fields of view, making them suitable for multi-channel coverage of the detected area. Therefore, several ultrasonic rangefinders can be operated in close proximity without mutual interference by sequencing their pulsed ultrasonic emissions over time. When the same transducer is used both to transmit and receive ultrasonic waves, however, detection of nearby objects is limited by the time required for the transducer to settle or “ring down” after it has been driven to emit the transmit pulse. During this time, objects cannot be detected.

One approach to this problem is to reduce the ringdown time, e.g., by antiphase driving of the transducer following the transmit pulse; see, e.g., U.S. Pat. No. 7,679,996. At the very least, this approach requires additional circuitry and/or controller programming. Alternatively, many existing single-channel ultrasonic ranging devices use two transducers, one to transmit and one to receive. While this avoids ringdown delay, the use of two transducers per detection channel adds cost and increases the size and mechanical complexity of a multi-channel system.

### SUMMARY

The present invention relates to systems and methods involving multiple ultrasound transducers that are capable of both transmitting and receiving detection signals. The transducers are selectively operated to achieve immunity to ringdown delays or to optimize the detection of distant objects. In the former case, object detection is performed within the field of a particular transducer channel by suppressing rather than activating that transducer; instead, the adjacent transducers on either side of the selected channel are driven simultaneously, and the selected channel's transducer is used only to receive. This eliminates the need to allow for transducer ringdown on the selected channel, and allows detection of nearby objects. In curved arrangements where the two adjacent transducers are aimed off-axis from the receive transducer, this approach sacrifices long-range detection performance in favor of short-range detection capability. While this trade-off does not theoretically apply to linear arrays of detectors that all point in the same direction, a linear array will typically be a useful geometry only if the transducers are spaced widely enough apart to cover a larger physical area; in such cases, the situation comes to resemble that of the circular array again, because the fields of view do not overlap to a large extent. Accordingly, the design trade-off between long-range and short-range detection capabilities will apply to circular arrays as well as practical linear arrays.

The order in which detector channels are operated may be staggered to maximize the time interval between the operation of spatially adjacent transducers and to prevent channel crosstalk. A staggered operation pattern provides adequate time for pairs of transducers to ring down fully before they are called upon to act as receivers.

Other activation patterns are also possible. For example, the pattern can dynamically change as a function of the range one or more detected objects, or the absence of any detected objects, or on command from a higher-level control system. In this way, the ultrasonic object detection system can achieve both optimized long-range performance and improved short-range capability as circumstances dictate.

Another embodiment of the invention optimizes the detection of distant objects by simultaneously firing all transducers to generate a single ultrasonic wave of greatly increased amplitude. After the transmission of the wave is complete, all transducers are simultaneously used as receivers to detect returned ultrasonic waves. This approach sacrifices close-range detection capability for improved long-range performance.

Accordingly, in a first aspect, the invention pertains to a method for operating a plurality of ultrasound transducers to detect objects. Each transducer emits and receives ultrasound within a spatial zone defined by a solid angle. In various embodiments, the method comprises the steps of selecting a spatial zone corresponding to a first transducer; causing second and third transducers, each positioned next to and on opposite sides of the first transducer, to emit a detection signal; detecting the signal by the second and third transducers but not the first transducer; and analyzing the detected signal to locate objects within the spatial zone. In some implementations, the transducers are arranged in a linear (e.g., straight or curved) succession of coplanar transducers, and the method further comprises sequentially causing different pairs of transducers to emit detection signals. When more than one pair of transducers simultaneously emits detection signals, the simultaneously emitting transducer pairs may be separated by at least one transducer that is not emitting detection signals. In other implementations, no more than one pair of transducers simultaneously emits detection signals, and pairs of transducers are operated in a sequence that maximizes a time interval between operation of adjacent transducers. Transducer pairs may be activated in a pattern responsive to a distance to one or more detected objects, or in response to the failure to detect any objects.

As noted, the linear cluster may be straight or curved. For example, the transducers may be arranged in a ring configuration so that the spatial zones collectively cover 360° relative to the ring.

In a second aspect, the invention relates to a method for operating a plurality of ultrasound transducers to detect objects. Each transducer emits and receives ultrasound within a spatial zone defined by a solid angle. In various embodiments, the method comprises the steps of causing all of the transducers to emit a detection signal; detecting, by all transducers, reflections of the emitted signals; and analyzing the detected reflections to locate objects within the spatial zones.

In a third aspect, the invention pertains to a system for tracking movement. In various embodiments, the system comprises a plurality of ultrasound transducers, and a controller for operating each of the transducers to emit and receive ultrasound within a spatial zone defined by a solid angle. The controller may be configured to select a spatial zone corresponding to a first transducer; cause second and third transducers, each positioned next to and on opposite sides of the first transducer, to emit a detection signal; detect the signal via the second and third transducers but not the first transducer; and analyze the detected signal to locate objects within the spatial zone.

In some embodiments, the transducers are arranged in a linear (e.g., straight or curved) succession of coplanar transducers, and the controller is configured to sequentially cause different pairs of transducers to emit detection signals. The controller may be configured to cause more than one pair of transducers to simultaneously emit detection signals, where the simultaneously emitting transducer pairs are separated by at least one transducer that is not emitting detection signals; or may be configured to cause no more than one pair of transducers to emit detection signals at any time, and to operate pairs of transducers in a sequence that maximizes the time interval between operation of adjacent transducers. The controller may be configured to sequentially activate pairs of transducers in a pattern responsive to a distance to at least one detected object, or in a pattern responsive to absence of any detected objects. The linear cluster may be straight or curved, e.g., arranged in a ring configuration so the spatial zones collectively cover 360° relative to the ring.

In a fourth aspect, the invention pertains to system for tracking movement. In various embodiments, the system comprises a plurality of ultrasound transducers; and a controller for operating each of the transducers to emit and receive ultrasound within a spatial zone defined by a solid angle. The controller may be configured to cause all of the transducers to emit a detection signal; cause all of the transducers to detect reflections of the emitted signals; and analyze the detected reflections to locate objects within the spatial zones.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology. Furthermore, the term “substantially” means±10%, and in some embodiments, ±5%.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1A schematically depicts an exemplary ultrasound transducer system.

FIG. 1B depicts transducer elements emitting and receiving ultrasound within a spatial zone defined by a solid detection angle.

FIG. 2 depicts ultrasound waves or pulses emitted into a space and detected as reflections from objects in the space.

FIG. 3 illustrates an iterative process for detecting moving objects.

FIG. 4 depicts the method of calculating the amplitude deviations.

FIG. 5 depicts the method of calculating the time averaged amplitude deviations over multiple wave cycles.

FIG. 6 depicts the method of calculating the short-time averaged amplitude deviations over multiple successive times within a wave cycle.

FIG. 7 depicts the method of calculating the peak-detected amplitude deviations within a wave cycle.

FIG. 8 depicts the method of calculating the spatial average of peak-detected amplitude deviations within a wave cycle.

### DETAILED DESCRIPTION

The following discussion describes a representative ultrasonic detection system whose performance may be extended using the approach of the present invention. It should be understood, however, that the applicability of the invention is not limited to any particular deployment; the approach described herein may be advantageously applied to virtually any multi-channel ultrasound-based detection system regardless of configuration.

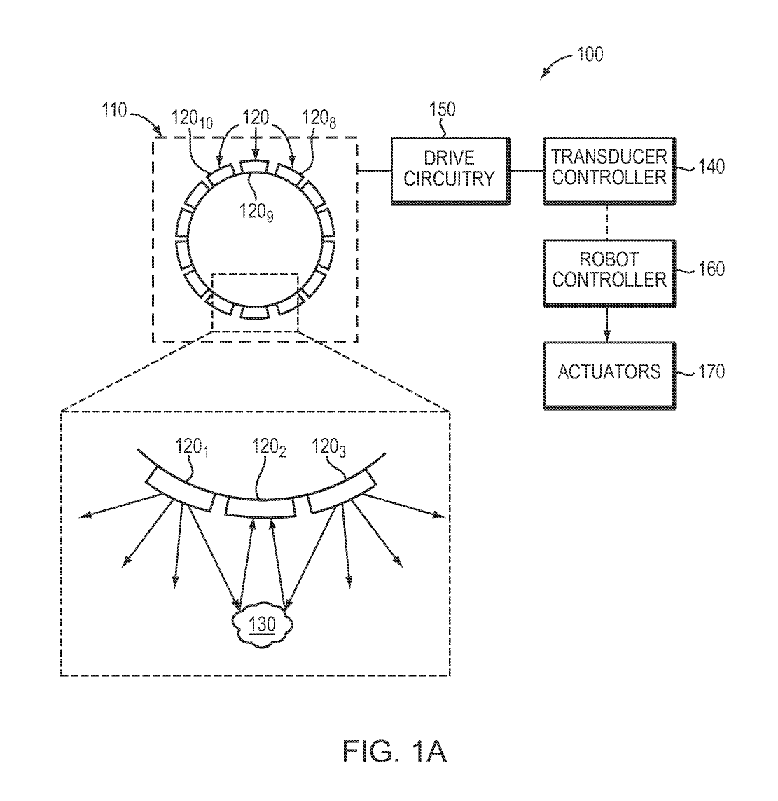

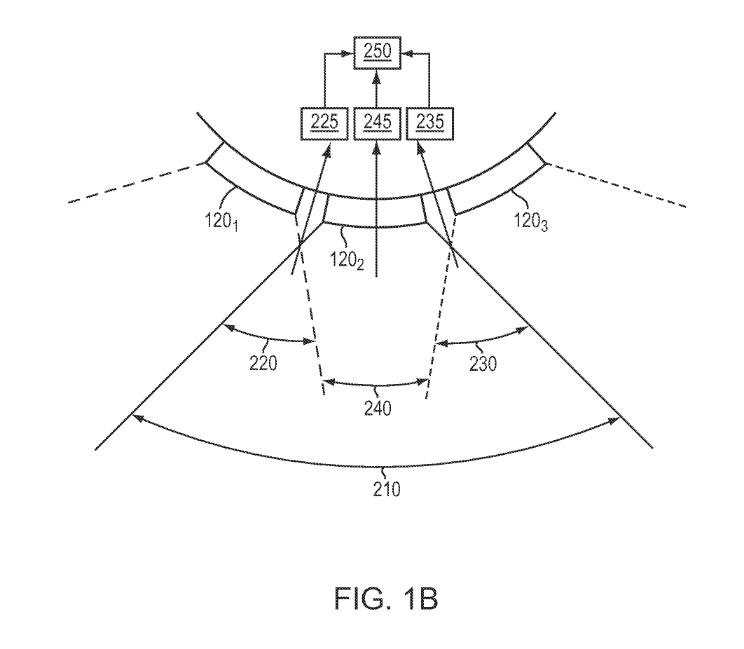

FIG. 1A depicts an exemplary ultrasound transducer system 100 in accordance with embodiments of the present invention, although alternative systems with similar functionality are also within the scope of the invention. As depicted, an ultrasound transducer 110 includes multiple transducer elements 120. Each transducer element may emit directional ultrasound waves or pulses towards an object 130, e.g., humans or equipment, and receive the reflected waves therefrom. The elapsed time between an ultrasound wave emission and the reception of a reflected wave can be used to determine the distance between the ultrasound emitter and the object causing the reflection. A transducer controller 140 regulates several aspects of the emitted ultrasound signals, e.g., frequency, phase, and amplitude, by controlling the transducer elements via the associated drive circuitry 150 (which sends signals to the transducer elements 120). In addition, the controller 140 may analyze the nearby spatial arrangements of the transducer based on the reflected signals as described in greater detail below.

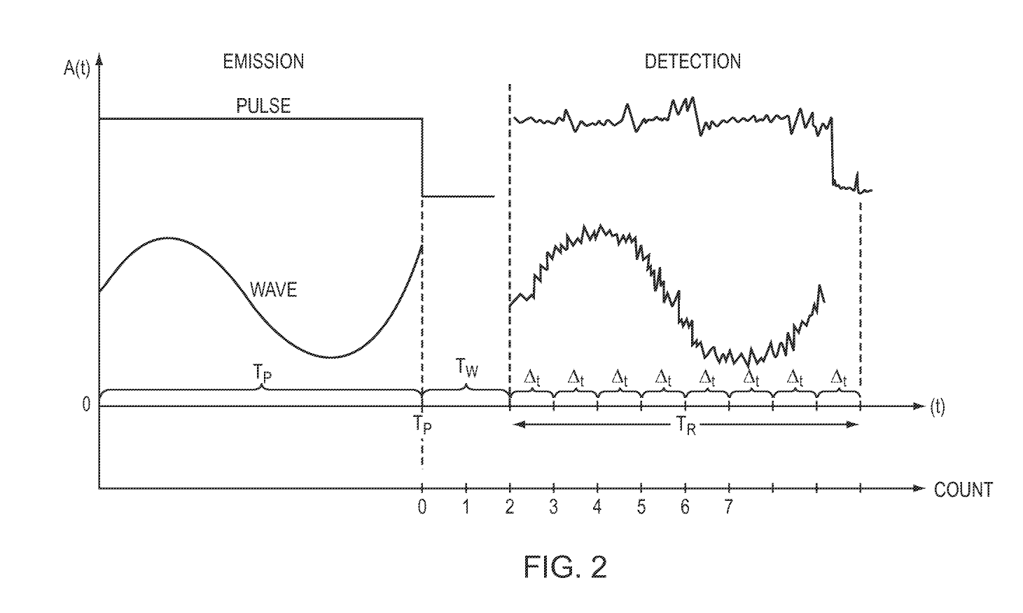

In one embodiment, each transducer element 120 is associated with a separate controller 140 and/or drive circuitry 150. The controllers and drive circuitry may use identical signal-processing circuits and have the same electrical and acoustic characteristics. In another embodiment, some or all of the transducer elements 120 are regulated by a single controller and drive circuitry. In various embodiments, the transducer elements 120 are arranged in a cluster (e.g., in a ring) with the fields of view extending outward from a single location in a common horizontal plane. Each element 120 emits and receives ultrasound within a spatial zone defined by a solid detection angle, as depicted in FIG. 1B. The transducer thus has a detection angle with a full 360 degree field of view. Within the solid detection angle of each transducer element (e.g., the angle 210 in FIG. 2), a portion of the angle may overlap with the detection angles of other elements (e.g., the angles 220, 230 in FIG. 2). It should be understood that the illustrated arrangement of transducers is exemplary only, and other arrangments—linear and straight rather than curved, two-dimensional, etc.—may be employed depending on the demands of a particular application.

In accordance with embodiments of the present invention, ringdown and crosstalk may be avoided by operating the transducer covering the spatial zone of interest to detect rather than to transmit signals, and using the adjacent transducers to emit detection signals into this zone. For example, with reference to FIGS. 1A and 1B, an object 130 may be within the spatial zone 210 associated with the transducer element 120₂, but to sense objects within this zone, the controller 140 causes the adjacent transducer elements 120₁, 120₃ to emit detection signals. Because of the overlap angles 220, 230, most of the zone 210 is covered, and so long as the object 130 is sufficiently distant from the transducer element 120₂ (i.e., it is not within the excluded angle 240), reflections therefrom will be detected by the transducer element 120₂. In various embodiments, this approach allows detection of objects as close as 5 cm from the transducer element 120₂ (as compared to a minimum of approximately 50 cm were the transducer element 120₂ used both to transmit and receive).

In some embodiments, the controller 140 operates more than one pair of transducer elements 120 to simultaneously emit detection signals, in which case the simultaneously emitting transducer pairs are separated (e.g., maximally separated) by transducer elements that are not emitting detection signals. In other embodiments, the controller 140 allows only a single pair of transducer elements to emit a detection signal. Pairs of transducer elements may be operated in a sequence that maximizes a time interval between operation of adjacent transducer elements, i.e., the order in which the transducer elements 120 are operated is staggered around the ring to maximize the time interval between the operation of spatially adjacent transducer elements and prevent channel crosstalk. For example, after the transducer elements 120₁, 120₃ have emitted a detection signal, the controller may next operate the maximally opposed transducer elements 120₈, 120₁₀ to emit detection signals for detection by the transducer element 120₉.

Other patterns of transducer activation may also be employed. For example, the controller 140 may simultaneously or sequentially activate pairs of transducer elements in a pattern responsive to the distance to at least one detected object. The transducer elements adjacent to the spatial zone in which a nearby object is detected, for example, may be operated more often than transducers associated with other spatial zones. This permits the movement of objects near the transducer array to be tracked with finer temporal resolution. Analogously, the controller 140 may orchestrate or adjust the pattern of activation based on the failure to detect objects within particular spatial zones, with transducer elements covering empty zones being activated less often than those associated with zones in which objects have been detected. Adjusting the activation pattern allows the system to achieve both optimized long-range performance and improved short-range capability as circumstances dictate.

In another embodiment, the controller 140 optimizes detection of distant objects by simultaneously driving all of the transducer elements 120 in the ring to generate a single circular ultrasonic wave of greatly increased amplitude. After the transmission of the wave is complete, all of the transducer elements 120 are simultaneously operated as receivers to detect returned ultrasonic waves. This approach sacrifices close-range detection capability for improved long-range performance.

In various embodiments the controller 140 may be provided as either software, hardware, or some combination thereof. For example, the system may be implemented on one or more server-class computers, such as a PC having a CPU board containing one or more processors such as the Core Pentium or Celeron family of processors manufactured by Intel Corporation of Santa Clara, Calif. and POWER PC family of processors manufactured by Motorola Corporation of Schaumburg, Ill., and/or the ATHLON line of processors manufactured by Advanced Micro Devices, Inc., of Sunnyvale, Calif. The controller may contain a processor that includes a main memory unit for storing programs and/or data relating to the methods described above. The memory may include random access memory (RAM), read only memory (ROM), and/or FLASH memory residing on commonly available hardware such as one or more application specific integrated circuits (ASIC), field programmable gate arrays (FPGA), electrically erasable programmable read-only memories (EEPROM), programmable read-only memories (PROM), or programmable logic devices (PLD). In some embodiments, the programs may be provided using external RAM and/or ROM such as optical disks, magnetic disks, as well as other commonly used storage devices.

For embodiments in which the controller is provided as a software program, the program may be written in any one of a number of high level languages such as FORTRAN, PASCAL, JAVA, C, C++, C#, LISP, PERL, BASIC, PYTHON or any suitable programming language. Additionally, the software can be implemented in an assembly language and/or machine language directed to the microprocessor resident on a target device.

The illustrated system may advantageously be deployed on an industrial robot. In general, an industrial robot is an automatically controlled, reprogrammable, multipurpose manipulator programmable in three or more axes. Most robots include robotic arms and/or manipulators that operate within a working envelope, and whose movements are driven by actuators operated by a robot controller; see, e.g., U.S. Pat. No. 5,650,704 and U.S. Ser. Nos. 12/843,540, filed on Jul. 26, 2010, and 13/159,047, filed on Jun. 13, 2011, the entire disclosures of which are hereby incorporated by reference. Thus, as illustrated, a robot controller 160 may control the kinematics of a robot, including movements of manipulators and appendages, by signals sent to actuators 170 in a manner well-known to those skilled in the art. Here, the controller 160 is responsive to signals from transducer controller 140. For example, when the transducer controller 140 detects a moving object in proximity to the robot's working envelope, it signals robot controller 160 which, in turn, disables all or the relevant actuators 170 whose operation might cause danger to the detected moving object. Of course, the controllers 140, 160 need not be separate entities, but may instead be implemented within a single overall system controller.

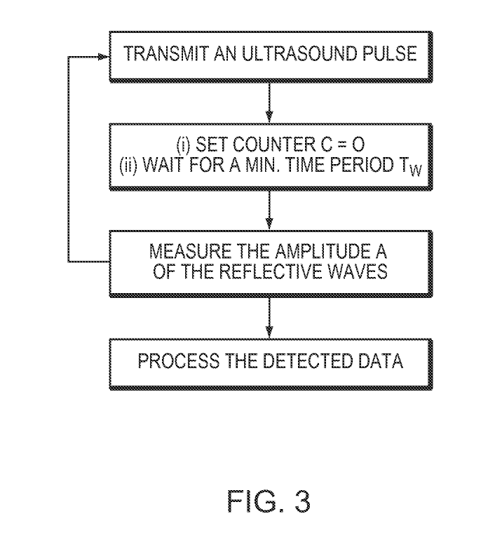

Referring to FIG. 2, in various embodiments, each transducer element emits an ultrasound wave (or pulse) having a duration of Tp within a spatial zone. The ultrasound waves (or pulses) may be emitted sequentially or simultaneously across zones. At the end of the wave (or pulse) signal, the transducer controller sets a counter C to zero counts. Throughout the detection procedure, the counter C increases at a fixed time interval Δt, the magnitude of which is determined based on a convenient unit of spatial resolution. For example, for a spatial resolution of 1 centimeter, Δt may be set to 58 μs, which is determined by the speed of sound in the air. The value of the counter C thus represents the distance of the object based on the time that transducer elements receive the reflected ultrasound waves. After transmission of the ultrasound wave (or pulse), a minimum time period T_{W} is allowed to elapse before measuring the amplitude of reflected waves. This allows for settling of the ultrasonic transducer detection system and ignores objects that are closer than the minimum detection range. Once T_{W} has elapsed, the transducer controller measures the amplitudes A of the reflected waves received by the transducer elements at each time interval Δt for a duration of T_{R} after the end of T_{W}. The measured amplitudes of reflective waves are then stored in memory—in particular, in an array indexed by the counter C, such that each array element, i.e., the data point, represents a measured amplitude A(t) at a specific time t related to a specific distance range in the current wave cycle. Each array element is then processed by the controller to determine locations and movements of the objects using a motion-detection algorithm, as described below. Once T_{R} has elapsed, the transducer elements emit an ultrasound signal and the detection cycle is repeated. FIG. 3 depicts the iterative process of adaptively detecting movements of moving objects in real time. In one embodiment, this detection cycle is operated with a time interval of, e.g., 200 milliseconds or less between each signal to optimize the time resolution of detecting moving objects.

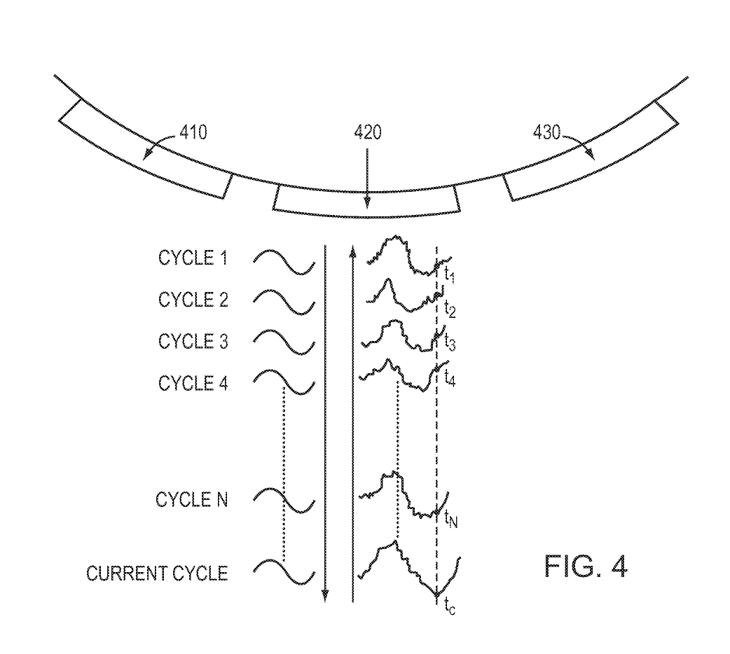

Each transducer element is independent and has its own data set. The motion-detection algorithm is designed to process the data set and determine the movements of the objects while ignoring stationary objects. The algorithm may be optimized for minimum computational overhead, so that it can be executed in real time using a low-cost microcontroller. Additionally, the motion-detection algorithm may identify and report multiple moving objects at different distances (ranges) with different velocities (bearings). With reference to FIG. 4, the principle of the algorithm is that, for each point in time, an amplitude deviation of the current reflected wave cycle, e.g., D(t_{c}), is calculated by subtracting the currently acquired amplitude A(t_{c}) with a long-term average amplitude reading, Ā(t), from prior detection cycles—e.g., from cycle 1 to cycle N, D(t_{c})=A(t_{c})−Ā(t). The amplitudes of the reflected ultrasound waves from stationary objects may be treated as a static background; the amplitude deviations contributed from the stationary objects are thus negligible. By contrast, the amplitude deviations of moving objects are dynamic and may be further processed with the associated elapsed times received by the transducer elements to determine the range and bearing of the moving objects.

In some embodiments, the amplitude deviation is determined within the duration of an echo, where the start of the echo occurs when a reflected wave has an amplitude above a predetermined maximum intensity threshold and the end of the echo occurs when the amplitude is below a predetermined minimum intensity threshold. A long-term average amplitude Ā(t) of the echoes at a time t, within the echo duration, is then subtracted from the measured echo amplitude A(t) at the time t in the current reflective cycle to derive an amplitude deviation D(t) for the time t.

The durations and states of the echoes may be changed in some conditions. For example, if the amplitude deviation is smaller than a specific minimum threshold Dₘᵢₙ and the minimum echo duration has been exceeded, the echo state may be changed from “true,” i.e. the echo exists, to “false,” i.e., the echo no longer exists; in this case, the controller is ready to detect another echo. If an amplitude deviation is larger than a specific maximum threshold Dₘₐₓ, the echo state may be changed from “false” to “true”; in this case the range data is added to the array of detected echoes, and the echo count increases by one. In one embodiment, Dₘᵢₙ and Dₘₐₓ are both predetermined values and can be adjusted based on, e.g., the long-term average amplitudes or the ranges of the detected objects, as further described below.

The long-term average amplitudes can be calculated utilizing any of several approaches, e.g., using a finite impulse response (FIR) filter or an infinite impulse response (IIR) filter. FIR filters have a fixed-duration impulse response; the long-term average amplitudes can be simply calculated from an average amplitude of N prior cycles, i.e.,

$$\overline{A} ( t ) = \frac{1}{N} ( A ( {t}_{1} ) + A ( {t}_{2} ) + A ( {t}_{3} ) + … + A ( {t}_{N} ) ) . \qquad ( 1 )$$

However, this approach requires additional memory to store multiple sets of data from previous cycles; it thereby increases the cost of implementation. IIR filters have an impulse response function that is non-zero over an infinite length of time; the long-term average amplitudes are calculated using a one-out-of-N algorithm as:

$$\overline{A} ( t ) = \frac{1}{N} ( \overline{A} ( {t}_{N - 1} ) \times ( N - 1 ) + A ( {t}_{N} ) ) . \qquad ( 2 )$$

At the end of each detection wave cycle, the long-term average amplitude may be updated utilizing eq. (2) to account for the measured echo amplitude in the current cycle. This approach provides an improved performance with lower memory usage and reduces the computational load. In one embodiment, the value of N is an integer power of 2; this allows the multiplication and division of integers to be replaced with left and right shift operations that are computationally less expensive.

In practice, the amplitude deviations from a spatial zone within a wave cycle based on the above definition may be noisy due to random variations of the amplitudes in the echo waves. Several approaches can be implemented for eliminating the random variations.

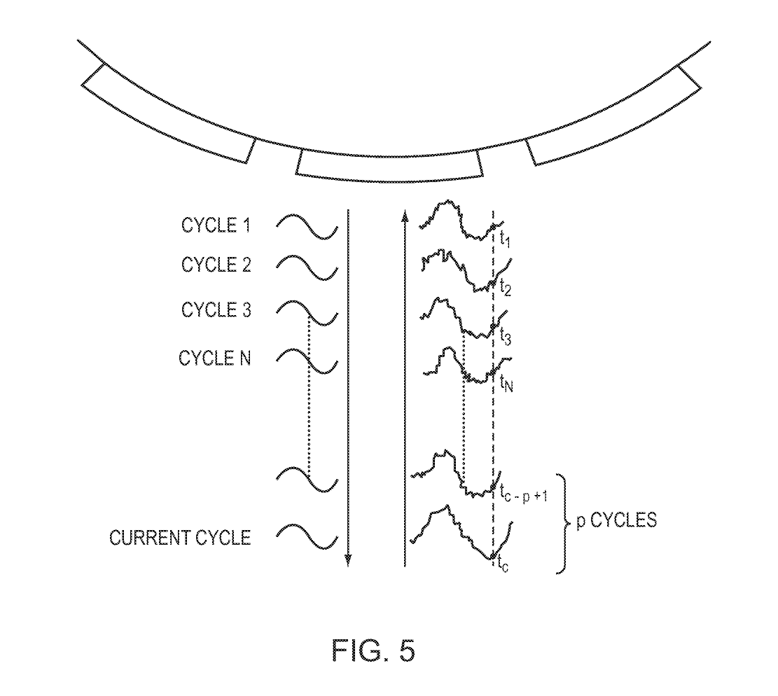

In various embodiments, the time-averaged amplitude deviations can be used for eliminating random variations in the echo amplitudes; it is useful in a situation where moving objects move relatively slow compared with the emitted frequency of the wave cycles. FIG. 5 depicts an exemplary time-averaged amplitude deviation over P wave cycles:

$${\overline{D}}_{w} ( {t}_{c} ) = \frac{1}{P} ( D ( {t}_{c - p + 1} ) + D ( {t}_{c - p + 2} ) + D ( {t}_{c - p + 3} ) + … + D ( {t}_{c} ) ) . \qquad ( 4 )$$

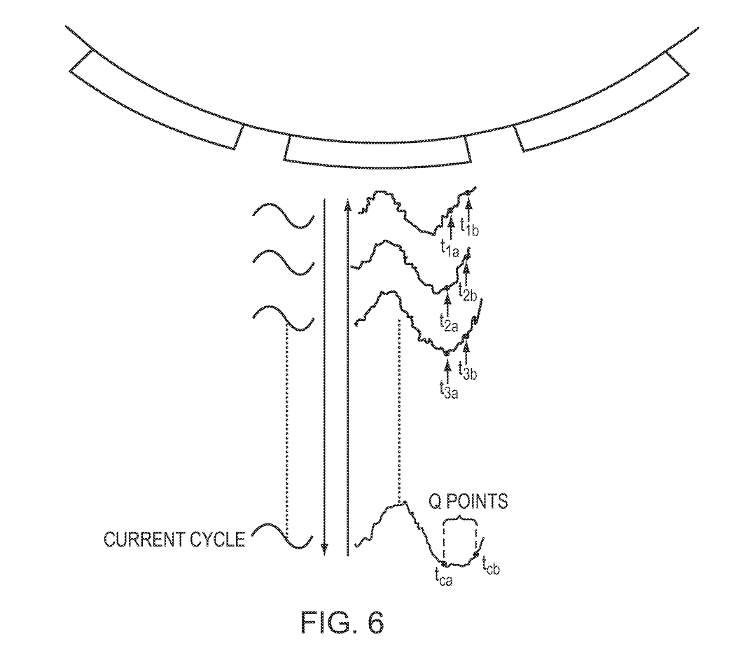

In other embodiments, short time-averaged amplitude deviations can be used to reduce random variations of the echo amplitudes within a wave cycle. For example, with reference to FIG. 6, the short time-averaged amplitude deviation between time t_{ca} and time t_{cb} in the current cycle is given as:

$${\overline{D}}_{st} ( {t}_{c} ) = \frac{1}{Q} ( D ( {t}_{ca} ) + D ( {t}_{ca + 1} ) + D ( {t}_{ca + 2} ) + … + D ( {t}_{cb} ) ) , \qquad ( 5 )$$

where Q is the number of data points received between time t_{ca} to t_{cb} within the current cycle.

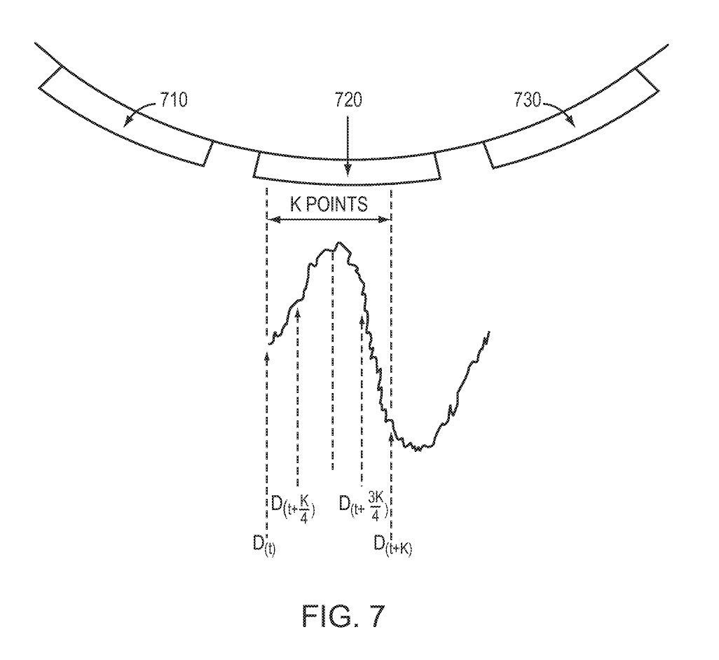

In various embodiments, the peak-detection algorithm is applied to improve the sensitivity of the detection algorithm to a steep rise in the amplitude deviation that is characteristic of the echo from an object of substantial size, e.g., a human. As depicted in FIG. 7, the peak-detection algorithm subtracts the amplitude deviations D(t) of the first K/4 data points from the total value and adds the last 3K/4 data points into the total value, as follows:

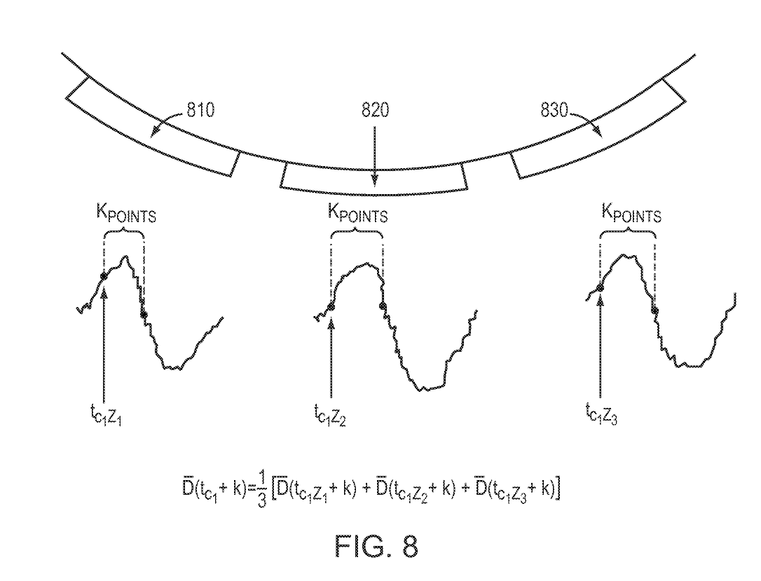

Dₚ(t+K)=scale factor×{(−1)×[D(t)+D(t+1)+D(t+2)+ . . . +D(t+(K/4))]+[D(t+(K/4)+1)+D(t+(K/4)+2)+ . . . +D(t+K−1)+D(t+K)]} (6).

where Dₚ (t+K) is the peak-detected amplitude deviation for time t+K, i.e., in the most recent K values of the amplitude deviation D(t) in the current wave cycle, as illustrated in FIG. 7. In one embodiment, as depicted in FIG. 8, movement detections of the objects can be determined based on an average of peak-detected amplitude deviations over adjacent spatial transducers (zones), e.g., 810, 820, and 830 in the current wave cycle; where

D̅_{p,z}(t+K)=⅓[ D̅(t_{c1z1}+K)+ D̅(t_{c1z2}+K)+ D̅(t_{c1z3}+K)] (7).

In various embodiments, Dₘᵢₙ and Dₘₐₓ, the predetermined minimum and maximum deviation thresholds, respectively, can be adjusted at each time t to reflect the various magnitude of the long-term average amplitude in various environments at time t. For example, Dₘᵢₙ and Dₘₐₓ are set as low values when the detection waves are transmitted in a region with low amplitudes of reflected waves; it thus increases the sensitivity of the algorithm in determining the amplitude deviations as well as the duration of echoes. In regions where large random fluctuations of the amplitude deviations are expected even in the absence of moving objects, adjusting Dₘₘ and Dₘₐₓ accordingly increases the immunity of the detection algorithm to such fluctuations. Dₘᵢₙ and Dₘₐₓ can also be adjusted to reflect the ranges of the detected objects. For example, for detecting more distant objects, Dₘᵢₙ and Dₘₐₓ are set as low values in order to increase the sensitivity of the algorithm; as the objects approach the detectors, Dₘᵢₙ and Dₘₐₓ may be adjusted to higher values since the amplitudes of reflected waves decay less significantly over a shorter distance.

The specific values used for Dₘᵢₙ and Dₘₐₓ in a given system strongly depend on the electronic, acoustic, and software design parameters of the system, including, e.g., the sensitivity of the ultrasonic detectors, the gain and offset voltage of the amplifier chain, or the supply voltage used to operate the detector system. Therefore, systems with identical functional performance (e.g., range, detection sensitivity, noise immunity, or response speed) may have different predetermined values of Dₘᵢₙ and Dₘₐₓ due to different components therein.

In an exemplary system with a gain of ˜2000 for an amplifier chain, 12 bits of resolution for a microcontroller's analog-to-digital converter (ADC), and 3.3 V of the supply voltage, each ADC count represents about 805 μV at the ADC, or 0.4 μV of electrical signal from the transducer. In this system, values of Dₘₐₓ can be in the range of 175 to 300, and values of Dₘᵢₙ at around 80. With the thresholds capable of dynamically adapting to the amplitude of the average, Dₘₐₓ may be set as 300, 250, and 175 for high, moderate, and low average signals, respectively. Alternatively, with the thresholds dynamically adapted based on the ranges of the objects, the values of Dₘₐₓ may be chosen as 300, 250, and 175 for close, intermediate, and long ranges, respectively.

Changing the acoustic environment of the transducer, e.g., changes in the ambient noise level at the ultrasonic frequencies to which the transducer elements are sensitive or the directions of the transducer elements, may result in false detection of moving objects. For example, when a noise source (e.g., a tool operated by compressed air) is switched on, the increased background signal level adds to the measured short-term amplitude deviation D(t), and can trigger false positive detections until the long-term average Ā(t) has adapted to the increased background level. Once the noise source to which the motion detector has adapted is switched off, the decreased background signal level may prevent detection of moving objects due to the decrease of all short-term amplitude deviations D(t) until the long-term average amplitude Ā(t) re-adapts. The adaptation of the long-term average amplitude to the new environment may take up to several wave cycles and thereby cause unexpected injuries to moving objects, e.g., humans in the environment. Movements of the transducer elements may also cause the measured short-term deviation D(t) to be erroneous, since the long-term average amplitudes Ā(t) of individual elements no longer reflect amplitudes of the echoes detected within the new field of view for each transducer element.

In various embodiments, detecting changes in the acoustic environment of the transducer elements can be implemented by tracking the integral of the measured amplitude deviations D(t) over time in each wave cycle. The integrated amplitude deviation, I_{dev}, can be calculated continuously for each transducer element with established maximum positive and negative thresholds. During a major change to the acoustic environment (e.g., the addition or removal of an ambient noise source, or rotation of the head of the transducer elements), I_{dev}, may have a large positive or negative value for some or all transducer elements. The motion-detecting algorithm, therefore, may be retrained to adapt to the new acoustic environment when the value of I_{dev} exceeds either the positive or negative thresholds. Once the long-term amplitude average Ā(t) has adapted to the new acoustic environment, I_{dev} may have a small value even in the presence of multiple moving objects due to their small short-term contributions. This approach minimizes a false detection resulting from changes in the environment.

While the motion detecting algorithm can be automatically and gradually adapted to a changed acoustic environment, adaptation may take a relatively long time. In one embodiment, adaptation is accelerated by suspending the normal motion detecting algorithm for a certain period, e.g., L cycles, and causing the detecting algorithm to rapidly retrain the new average amplitude Ā_{new}(t) as the average of the amplitudes A(t) measured during the retraining period, e.g., L cycles. Ā_{new}(t) is thus given as:

$${\overline{A}}_{new} ( t ) = \frac{1}{L} ( {A}_{1} ( t ) + {A}_{2} ( t ) + {A}_{3} ( t ) + … + {A}_{L} ( t ) ) . \qquad ( 8 )$$

At the end of the retraining period (i.e., L cycles), the normal detecting algorithm resumes and the old amplitude average Ā(t) is replaced with the new amplitude average Ā_{new}(t), which is now accurately adapted to the new acoustic environment. In one embodiment, the adaption process can be automatically triggered for each transducer element when I_{dev} of the transducer element exceeds a predetermined threshold. In another embodiment, all transducer elements together are subjected to the retraining process upon detecting I_{dev} of a single transducer element and/or I_{dev} of all transducer elements exceeding a predetermined threshold. This can be done at the transducer startup, and/or by external command, and/or automatically by the transducer in response to detecting major changes in its acoustic environment.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method for operating a plurality of ultrasound transducers to detect objects, each transducer emitting and receiving ultrasound within a spatial zone defined by a solid angle, the method comprising the steps of:
selecting a spatial zone corresponding to a first transducer;
causing second and third transducers, each positioned next to and on opposite sides of the first transducer, to emit a detection signal;
detecting the signal by the second and third transducers but not the first transducer; and
analyzing the detected signal to locate objects within the spatial zone.

2. The method of claim 1, wherein the transducers are arranged in a linear succession of coplanar transducers, and further comprising the step of sequentially causing different pairs of transducers to emit detection signals.

3. The method of claim 2, wherein more than one pair of transducers simultaneously emits detection signals, the simultaneously emitting transducer pairs being separated by at least one transducer that is not emitting detection signals.

4. The method of claim 2, wherein no more than one pair of transducers simultaneously emits detection signals, and pairs of transducers are operated in a sequence that maximizes a time interval between operation of adjacent transducers.

5. The method of claim 2, wherein pairs of transducers are sequentially activated in a pattern responsive to a distance to at least one detected object.

6. The method of claim 2, wherein pairs of transducers are sequentially activated in a pattern responsive to absence of any detected objects.

7. The method of claim 2, wherein the linear cluster is curved.

8. The method of claim 5, wherein the transducers are arranged in a ring configuration and the spatial zones collectively cover 360° relative to the ring.

9. A method for operating a plurality of ultrasound transducers to detect objects, each transducer emitting and receiving ultrasound within a spatial zone defined by a solid angle, the method comprising the steps of:
causing all of the transducers to emit a detection signal;
detecting, by all transducers, reflections of the emitted signals; and
analyzing the detected reflections to locate objects within the spatial zones.

10. A system for tracking movement, the system comprising:
a plurality of ultrasound transducers; and
a controller for operating each of the transducers to emit and receive ultrasound within a spatial zone defined by a solid angle, the controller being configured to:
select a spatial zone corresponding to a first transducer;
cause second and third transducers, each positioned next to and on opposite sides of the first transducer, to emit a detection signal;
detect the signal via the second and third transducers but not the first transducer; and
analyze the detected signal to locate objects within the spatial zone.

11. The system of claim 10, wherein the transducers are arranged in a linear succession of coplanar transducers, the controller being further configured to sequentially cause different pairs of transducers to emit detection signals.

12. The system of claim 11, wherein the controller is configured to cause more than one pair of transducers to simultaneously emit detection signals, the simultaneously emitting transducer pairs being separated by at least one transducer that is not emitting detection signals.

13. The system of claim 11, wherein the controller is configured to cause no more than one pair of transducers to emit detection signals at any time, and to operate pairs of transducers in a sequence that maximizes a time interval between operation of adjacent transducers.

14. The system of claim 11, wherein the controller is configured to sequentially activate pairs of transducers in a pattern responsive to a distance to at least one detected object.

15. The system of claim 11, wherein the controller is configured to sequentially activate pairs of transducers in a pattern responsive to absence of any detected objects.

16. The system of claim 11, wherein the linear cluster is curved.

17. The system of claim 16, wherein the transducers are arranged in a ring configuration and the spatial zones collectively cover 360° relative to the ring.

18. A system for tracking movement, the system comprising:
a plurality of ultrasound transducers; and
a controller for operating each of the transducers to emit and receive ultrasound within a spatial zone defined by a solid angle, the controller being configured to:
cause all of the transducers to emit a detection signal;
cause all of the transducers to detect reflections of the emitted signals; and
analyze the detected reflections to locate objects within the spatial zones.
